(19) United States
(12) Patent Application Publication
(10) Pub. No.: US 2025/0190972 A1
(43) Pub. Date: Jun. 12, 2025

(54) SYSTEMS AND TECHNIQUES TO PERFORM CARD FUNCTIONS IN A COMPUTER ENVIRONMENT

(71) Applicant: Capital One Services, LLC, McLean, VA (US)

(72) Inventors: Kevin OSBORN, Newton Highlands, MA (US); Casey BARRETT, Kensington, MD (US); Narmeen RAHMAN, New York, NY (US)

(21) Appl. No.: 18/972,385

(22) Filed: Dec. 6, 2024

Related U.S. Application Data
(60) Provisional application No. 63/608,113, filed on Dec. 8, 2023.

(51) Int. Cl. G06Q 20/32; G06Q 20/40; H04L 9/40

(52) U.S. Cl. CPC G06Q 20/3278; G06Q 20/322; G06Q 20/401; H04L 63/0428

(57) ABSTRACT

Disclosed herein are systems and methods to perform card functions in a computer environment. In some embodiments, a switchboard node is provided. The switchboard node receives a request to establish a validation session. The validation session is established and encrypted data from a contactless card is validated by a validator. Once the encrypted data is validated, the switchboard node requests that an issuer server completes a requested function. The issuer completes a portion of the function and then encrypts a message to a merchant indicating to the merchant that the function is complete. The encrypted message is received and decrypted by the merchant and the merchant completes the remainder of the function in communication with a user device.

### CROSS-REFERENCE TO RELATED APPLICATION

The present application claims priority to U.S. Provisional Patent Application No. 63/608,113, filed on Dec. 8, 2023, the contents of which are incorporated herein in their entirety.

### BACKGROUND

Contactless card products have become so universally well-known and ubiquitous that they have fundamentally changed the manner in which security verifications, transactions, and dealings are viewed and conducted in society today. Contactless card products are most commonly represented by plastic or metal card-like members that are offered and provided to customers through card issuers (such as banks, financial institutions, gyms, apartment complexes, workplaces, and the like). With a card, an authorized cardholder is able to perform various functions that ordinarily would require an exchange of physical property, verification of an identification card, remembering or entering a password, or other requirements. Data security and transaction integrity are of critical importance to businesses facilitating these transactions and to the cardholders. This need continues to grow as functions performed with contactless cards constitute an increasingly large share of commercial and other daily activity.

As more cards are being used in this way and more systems include contactless card functionality, it may be difficult to distinguish card usage for multiple functions simultaneously or to process multiple cards performing the same or different functions simultaneously. Accordingly, there is a need to provide organizations and cardholders with an appropriate solution that overcomes current deficiencies to provide data security, authentication, and verification for contactless cards.

### SUMMARY

In one aspect, a method includes receiving, at a server, a first request to perform a function, the first request being associated with a user account associated with a contactless card, transmitting, by the server to a switchboard node, a validation session request to initiate a validation session for the contactless card, receiving, at the server, a response, including a nonce, from the switchboard node, transmitting, by the server to a user device associated with the user account, the nonce, where the user device is to send the nonce to the contactless card during a near field near-field communication (NFC) exchange with the contactless card, receiving, at the server from the contactless card, via the user device, encrypted data, the encrypted data including the nonce, transmitting, by the server to the switchboard node, the encrypted data, including the nonce, where the switchboard node is configured to forward the encrypted data to a validation server to validate the encrypted data, receiving, by the server from the validation server, a notification that the encrypted data is validated, and performing, by the server, the function as defined in the first request.

In one aspect, a switchboard node includes a processing circuit. The switchboard node also includes a memory includes instructions which when executed by the processing circuit, cause the processing circuit to receive, from a user device, a request for a first validation session, the first validation session being associated with a function request from a user account associated with a contactless card, establish the first validation session and, as part of establishing the first validation session, generate a unique nonce associated with the first validation session to distinguish the first validation session from any other validation sessions, transmit the nonce to the user device, receive a reply from the user device, the reply includes encrypted data from the contactless card and the nonce to indicate the encrypted data is associated with the first validation session, transmit the encrypted data to a validation server to validate the encrypted data, receive, from the validation server, an indication that the encrypted data has been validated, the indication including a validation token, and transmit, to an issuer server, the validation token along with instructions to complete a function associated with the function request.

In one aspect, a non-transitory computer-readable storage medium having instructions stored thereon, which when executed by a processor cause the process to receive a request for a first validation session, the first validation session being associated with a function request from a user device associated with a contactless card, establish the first validation session and, as part of establishing the first validation session, generate a unique nonce associated with the first validation session to distinguish the first validation session from any other validation sessions, transmit the nonce to the user device for the user device to send to the contactless card during a near field near-field communication (NFC) exchange between the user device and the contactless card, receive a reply from the contactless card via the user device, the reply includes encrypted data and the nonce to indicate the encrypted data is associated with the first session, transmit the encrypted data to a validation server to validate the encrypted data, receive, from the validation server, an indication that the encrypted data has been validated, the indication including a validation token, and send, to an issuer server, the validation token along with instructions to complete a function associated with the function request.

Non-transitory computer program products (e.g., physically embodied computer program products) are also described that store instructions, which, when executed by one or more data processors (e.g., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

FIG. 1 is a network diagram of an example system in accordance with one embodiment.

FIG. 2A and FIG. 2B illustrate a sequence flow diagram in accordance with one embodiment.

FIG. 3 is a block diagram of an example switchboard node in accordance with one embodiment.

FIG. 4 is a flow chart illustrating example operations of a method in accordance with one embodiment.

FIG. 5 is a flow chart illustrating example operations of another method in accordance with one embodiment.

FIG. 6 illustrates a contactless card in accordance with one embodiment.

FIG. 7 illustrates a transaction card component in accordance with one embodiment.

FIG. 8 illustrates a sequence flow diagram in accordance with one embodiment.

FIG. 9 illustrates an example of a system configured to operate in accordance with embodiments discussed herein.

FIG. 10 illustrates an aspect of the subject matter in accordance with one embodiment.

FIG. 11A illustrates an aspect of the subject matter in accordance with one embodiment.

FIG. 11B illustrates an aspect of the subject matter in accordance with one embodiment.

FIG. 11C illustrates an aspect of the subject matter in accordance with one embodiment.

FIG. 12 illustrates an aspect of the subject matter in accordance with one embodiment.

FIG. 13 is a flow chart illustrating various operations of an example method in accordance with one embodiment.

FIG. 14 is a block diagram of an example computing device in accordance with one embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. It is understood that the features, advantages, and characteristics of any embodiment may be interchangeably combined with the features, advantages, and characteristics of any other embodiments.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

Further embodiments are systems and techniques to perform card functions in a computer environment. In an example embodiment, a user will request a function be performed. For example, they may access a website and attempt to create a new account on the website an need to verify their identity. As part of this request for a function to be performed, the web server for the website will request a validation session be initiated with switchboard node as described herein. The switchboard node will generate the validation session, and as part of the validation session will generate a nonce and obtain the terms of service (ToS) for the website account generation. The nonce and the ToS are sent to the user device and the user device taps their contactless card to their user device. During the tap, the nonce is sent to the contactless card and the card replies with encrypted data and the nonce.

The user also reviews and accepts the ToS and the ToS approval timestamp and encrypted data is sent to the switchboard node. The switchboard node determines, based on the nonce, a validator for validating the encrypted data and sends the encrypted data to the validator to be encrypted. The switchboard node also sends messages to the web server and an issuer server to negotiate a key between the web server and the issuer so that they can decrypt messages sent therebetween. Once the validator validates the encrypted data, the switchboard node instructs the issuer server to complete at least a part of the function, for example, telling the web server that the account holder's identity has been validated and the account with the website can be created. The web server then creates the user account to complete the function.

This describes, at a high-level, one example embodiment of a function performed by the validation session as described herein. Various other functions can be performed as described herein.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

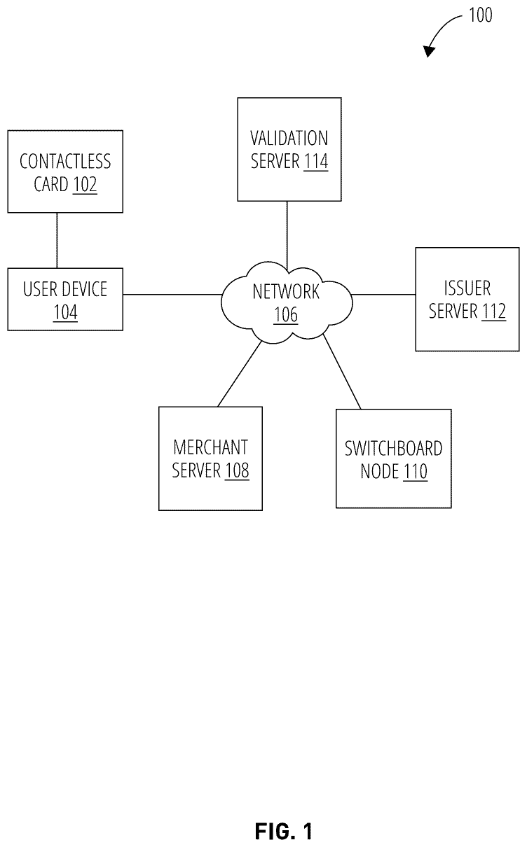

FIG. 1 is a network diagram of a system 100 for performing card functions in a computer environment, according to an example embodiment. As further discussed below, system 100 may include contactless card 102, user device 104, network 106, merchant server 108, switchboard node 110, issuer server 112, and validation server 114. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with user device 104.

System 100 may include user device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. User device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 104 can include a processor and a memory, and it is understood that the processing circuitry may comprise additional components, including processors, memories, error and parity/CRC checkers, data encoders, anticollision algorithms, controllers, command decoders, security primitives and tamperproofing hardware, as necessary to perform the functions described herein. The user device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, user device 104 of system 100 may execute one or more applications, such as software applications, that enable, for example, network communications with one or more components of system 100 and transmit and/or receive data. The application can also enable the user device 104 to communicate with the merchant server 108 and the switchboard node 110.

The user device 104 may be in communication with one or more server(s) via one or more network(s) 106. The user device 104 may transmit, for example from a mobile device application executing on user device 104, one or more requests to merchant server 108 and switchboard node 110. The one or more requests may be associated with sending or retrieving data from the merchant server 108 or the switchboard node 110. The user device 104 can also communicate with the issuer server 112. The switchboard node 110 may receive one or more requests from user device 104. Based on the one or more requests from user device 104, merchant server 108 may be configured to retrieve the requested data from one or more databases (not shown). Based on receipt of the requested data from the one or more databases, merchant server 108 may be configured to transmit the received data to user device 104, the received data being responsive to one or more requests.

System 100 may include one or more networks 106. In some examples, network 106 may be one or more of a wireless network, a wired network or any combination of wireless network and wired network, and may be configured to connect user device 104 to switchboard node 110. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include a merchant server 108 such as a merchant transaction server, a web server hosting a website, a virtual private network (VPN) server, a server hosting an application, a server maintaining rewards for a rewards account, or any other suitable server. The server can comprise one or more processors, which are coupled to memory. The memory can include instructions stored therein, which when executed cause the merchant server 108 to perform various functions described herein. In some embodiments, the merchant server 108 is configured to communicate with the user device 104 to complete a function request (e.g., creating a website account, executing a transaction, establishing a VPN connection, creating a rewards account, perform an autofill function, login to an account, actuate a controller, or any other suitable function described herein) received from the user device 104. The functions described herein include any action or information a merchant, enterprise, apartment complex, gym, website host, rewards account processor, or other entity wishes to receive from an issuer of the contactless card using a tap from the contactless card.

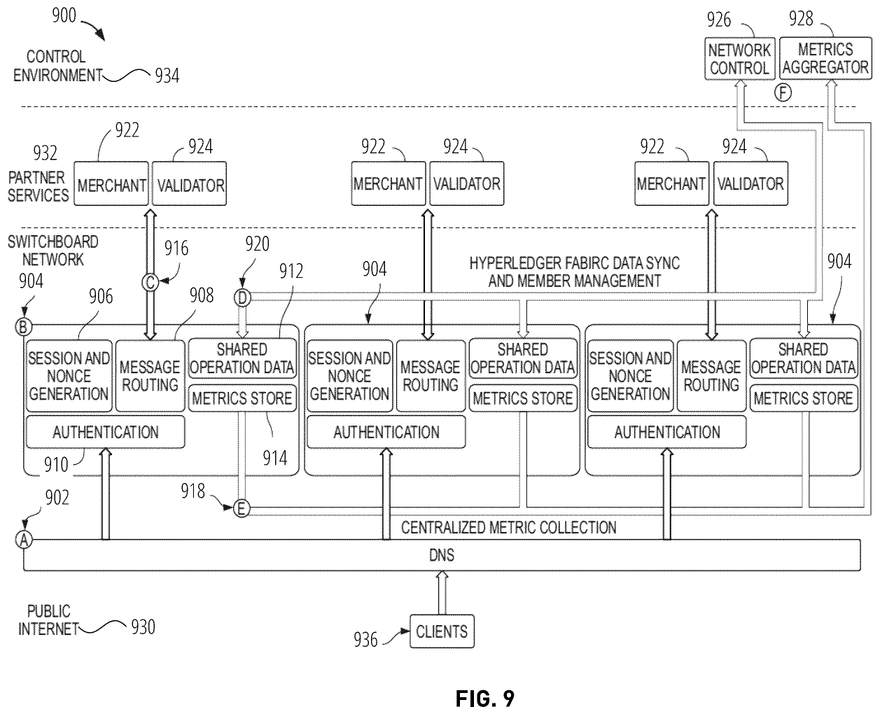

System 100 may include one or more switchboard nodes 110. The switchboard node 110 can include a server operating as a node in a switching network such as the switching network illustrated in system 900 shown in FIG. 9. The switchboard node 110 can be the switchboard node 904 in FIG. 9. In some examples, switchboard node 110 may include one or more processors, which are coupled to memory. The switchboard node 110 may be configured to perform various operations as described herein. For example, the switchboard node 110 is configured to communicate with the user device 104 to receive the encrypted data from the contactless card 102. The switchboard node 110 is further configured to send the encrypted data from the contactless card 102 to the validation server 114 to validate the encrypted data as described herein. Moreover, the switchboard node 110 is configured to communicate with the merchant server 108 to instruct the merchant server 108 to communicate with the issuer server 112 as described herein.

System 100 may further include an issuer server 112. The issuer server 112 is a server managed by the issuer of the contactless card 102. The issuer server 112 may be managed by a financial institution, bank, security service, apartment complex, business, enterprise, gym, etc. The issuer provides authorizations, for example, an authorization to perform a function as described herein. For example, the issuer server 112 may be configured to approve a transaction, approve a website account, approve a VPN be generated, approve access to an apartment complex or gym, or approve any suitable function described herein. In some embodiments, the issuer server 112 comprises one or more processors coupled with a memory, the memory having instructions stored thereon, which when executed, cause the issuer server 112 to perform the functions described herein.

System 100 may further include a validation server 114. In some embodiments, the validation server 114 comprises one or more processors coupled to a memory, the memory having instructions stored thereon, which when executed by the one or more processors, cause the validation server 114 to perform various operations described herein. For example, the validation server 114 receives the encrypted data of the contactless card 102 from the switchboard node 110 and validates the encrypted data.

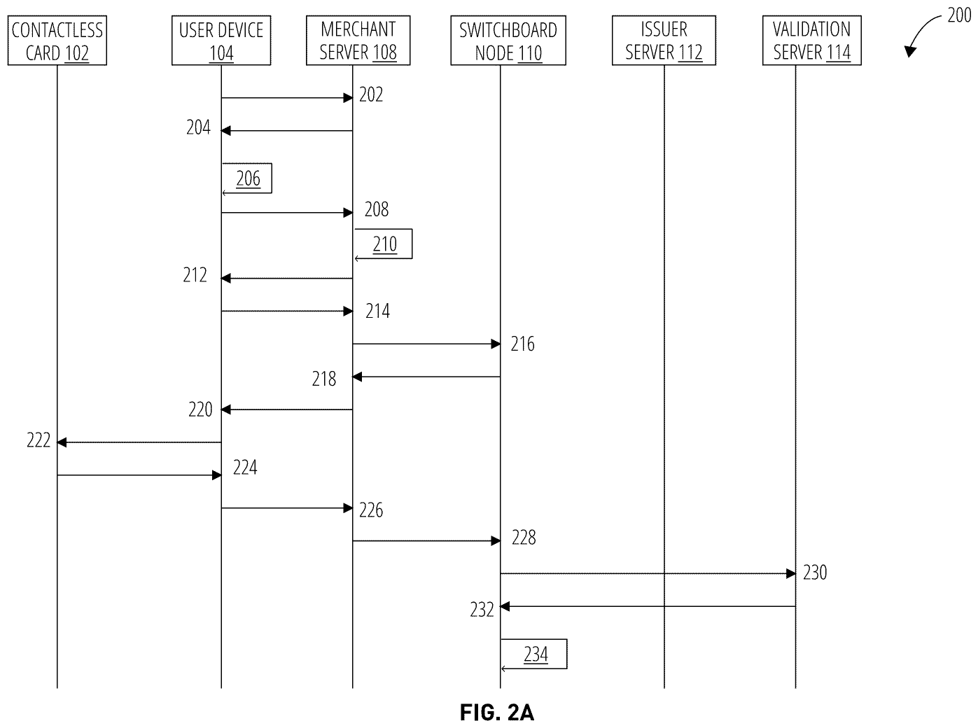

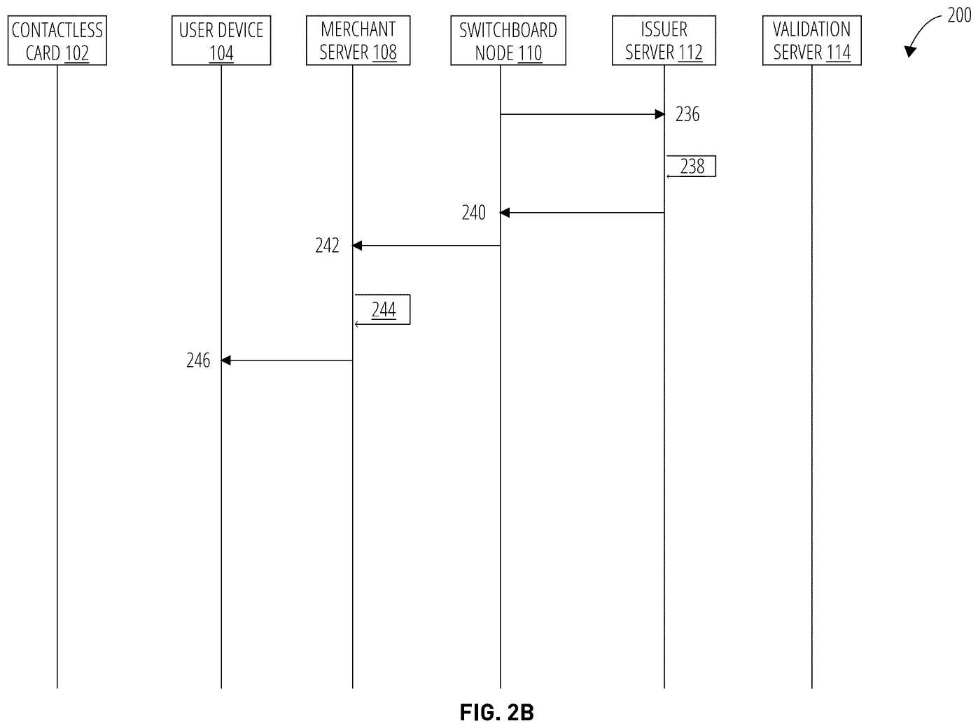

FIG. 2A and FIG. 2B are a sequence diagram 200 illustrating steps in an example sequence of a validation session according to some embodiments of the present disclosure. FIG. 2A illustrates a first portion of the sequence diagram 200, and FIG. 2B illustrates a second portion thereof. The sequence diagram 200 illustrates a flow of communications between the contactless card 102, user device 104, merchant server 108, switchboard node 110, issuer server 112, and validation server 114 to complete a function such as any of the functions described herein. When referring to operations performed by the user device 104, a user application operating on the user device 104 may perform some or all of the functions described herein. In some other embodiments, a combination of the user application, the OS of the user device 104, or hardware resources (e.g., an antenna) of the user device 104 may perform the functions described herein. As such, the following description refers to the user device 104 itself as performing the functions to encompass all possibilities. In some embodiments at 202, the user device 104 accesses the merchant server 108 and attempts to perform a function as described herein. For example, the user device 104 attempts to execute a transaction with the merchant server 108. Although, FIG. 2A is described with respect to execution of a transaction as the function being performed, this should not be construed as limiting the present disclosure, and any function described herein can be performed.

At 204, the merchant server 108 sends a message back to the user device 104 to initiate the transaction and trigger a pop-up application, namely a switchboard software development kit (SDK) to be triggered on the user device 104. The message from the merchant server 108 to the user device 104 includes a merchant session key for the transaction as well. The switchboard SDK is a program that operates on the user device 104 that helps facilitate the execution of the transaction by allowing the user device 104 to receive encrypted data from the contactless card 102 and send the encrypted data to the switchboard node 110. To perform this process, at 206, the switchboard SDK is executed on the user device 104. To help facilitate execution of the transaction, at 208, the user device 104 generates a client session ID and sends it to the merchant server 108. The user device 104 further generates an elliptic-curve Diffie-Hellman (ECDH) key request and sends it to the merchant server 108 for the merchant server 108 to generate one half of an ECDH key for later encryption/decryption of messages later on. The ECDH key request includes the client session ID generated by the user device 104.

At 210, the merchant server 108 generates a client ECDH public key and a client ECDH private key using Elliptic Curve P256. The client ECDH public key is then encoded in base 64. Next, the merchant server 108 creates client session information, which includes the client session ID received from the user device 104, a client ID, the client ECDH public key, and a client ECDH public key ID. The merchant server 108 then generates a client session token, which is a JavaScript Object Notation (JSON) Web Token (JWT) token containing the client session information, and the client session token is signed with the client ECDH private key. The merchant server 108 then stores the client ECDH private key with the client session token in a client key store (not shown, but can be a database stored on the merchant server 108, or any other server, for example) for later use.

At 212, the merchant server 108 returns the client session token to the user device 104. At 214, the user device 104, via the switchboard SDK sends the merchant server 108 a request for a validation session initiation, the validation session for validating encrypted data to be received from the contactless card 102. The validation session request sent by the switchboard SDK to the merchant server 108 includes a desired function (e.g., in this case execution of the transaction, but can be any function described herein) and the client session token, which includes the JWT token containing the client session information. Again, the client session information includes the client session ID received from the user device 104, a client ID, the client ECDH public key, and a client ECDH public key ID. The request from the user device 104, that includes the client session token, is sent to the merchant server 108 and at 216, the merchant server 108 forwards the request that includes the client session token to the switchboard node 110.

At 218, the switchboard node 110 generates a node session token and a nonce to distinguish this validation session from all other validation sessions being processed by the switchboard node 110. The nonce and node session token, which contains the nonce, an expiration time for the session, the client session token, and a list of issuers is sent back to the merchant server 108. In some embodiments, the function being performed, for example, establishing a VPN, creating a user account or a rewards account, etc., may require terms of service (ToS) to be accepted by the user. Ins such embodiments, the ToS and a ToS version identifier are sent to the user device 104 for the requested function. In some embodiments, before the node session token and the nonce and other data are sent to the user device 104, the switchboard node 110 may confirm that the user is eligible to request the given session. For example, the switchboard node 110 may inspect the client ID or device fingerprint and compare any of those to a predetermined list of allowed client IDs or device fingerprints to verify that the user is eligible.

In some embodiments, the node session token includes a JavaScript Object Notation (JSON) Web Token (JWT) signed with the switchboard node 110 private key. In some embodiments, the nonce is a unique string of 8 bytes of ASCII HEX encoded 4 bytes binary data. The nonce is a unique string to help distinguish this validation session with other validation sessions completed by the switchboard node 110. The node session token includes claims which comprise data elements such as the nonce, business function details, entity IDs, an expiration date, etc., of the node session token. The switchboard node 110 uses a public/private key cryptography to generate a signature for the node session token, thereby allowing other parties, such as the user device 104 to verify the authenticity of the claims within the node session token, using a well-known public key.

At 220, the nonce, node session token, and list of issuers is sent from the merchant server 108 to the user device 104.

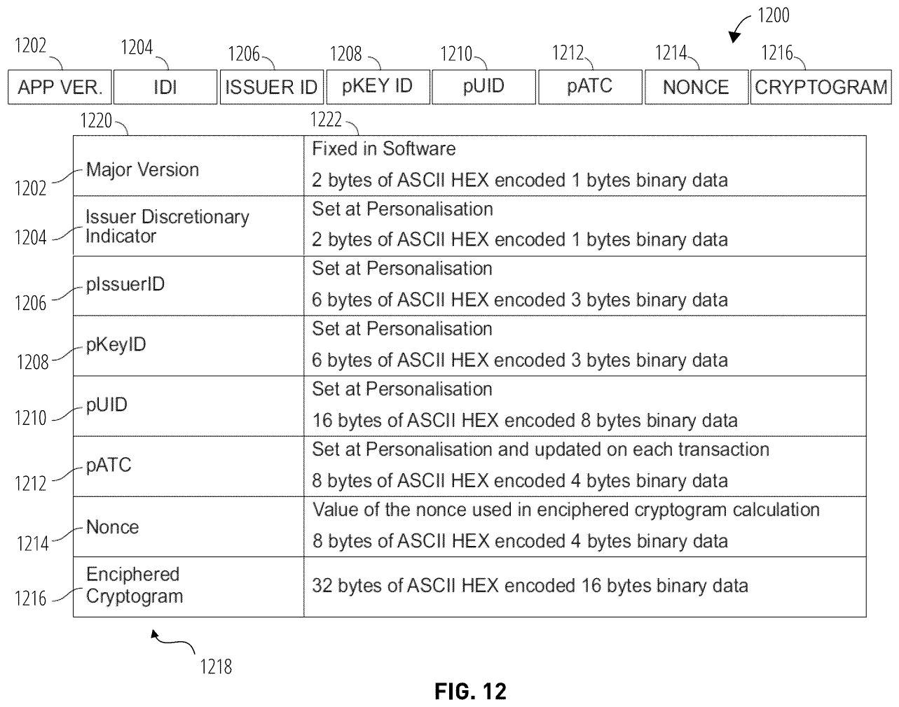

At 222, once the node session token is sent to the user device 104, the user device 104 extracts the nonce and sends the nonce to the contactless card 102. If ToS is part of the session, the ToS is sent to the user device 104 as well and a user interface is displayed on the user device 104 for the user to accept the ToS. The user then consents to the ToS and a timestamp is entered for when the ToS is accepted by the user. The user taps their contactless card 102 to their user device 104 and in an NFC exchange, the nonce is sent to the contactless card 102 and, at 224, the contactless card 102 sends back encrypted data, such as message 1200 shown in FIG. 12, for validating an identity of the user. The switchboard SDK (operating on the user device 104) receives the encrypted data and the nonce back from the contactless card 102.

At 226, the switchboard SDK sends the encrypted data, the node session token (e.g., including the nonce), and the ToS acceptance timestamp back to the merchant server 108. The merchant server 108 then generates a client request token that contains the node session token and the encrypted data, along with validation scope information and the ToS consent timestamp. At 228, the merchant server 108 forwards the client request token to the switchboard node 110 for validation of the encrypted data.

At 228, the switchboard node 110 received the client request token, which includes the encrypted data, the node session token, which includes the nonce, and ToS consent timestamp from the user device 104, and at 230, the switchboard node 110 determines a validation server 114 to send the encrypted data to for validation thereof. This may include the switchboard node 110 verifying the client request token signature and extracting the node session token and the encrypted data. Using the issuer identifier in the encrypted data (see Issuer Identifier 1206 in the message 1200 in FIG. 12), the switchboard node 110 determines the URL of the validation server 114 based on the issuer identifier in the encrypted data. The switchboard node 110 then generates a validation request token containing the client request token and at 230, the switchboard node 110 then sends the validation request token to the URL corresponding to the URL of the validation server 114.

At 232, the validation server 114 then completes validation of the encrypted data by decrypting the data from the contactless card 102 and verifying that it matches expected data for the contactless card 102. At 232, the validation server 114 then returns a validation token (e.g., a JWT that contains the validation request token and signed with the issuer server 112 private key) to the switchboard node 110 to indicate that the encrypted data from the contactless card 102 is validated. In some embodiments, the validation token comprises the encrypted data from the contactless card 102, an expiration date of the validation token, an identifier of the validation server 114, and the node session token described above.

At 234, the switchboard node 110 uses the encrypted data issuer identifier to select a function fulfiller to use, and then the switchboard node 110 begins to assemble a request to the issuer server 112 to continue completion of the desired function.

FIG. 2B illustrates a continuation of the sequence diagram 200 from FIG. 2A. At 236, the switchboard node 110 sends a function request message to the issuer server 112, the function request message including the validation token (which includes the node session token), the merchant public key, and the ToS consent timestamp, if ToS is necessary. In the example given above regarding completion of a transaction, ToS is not necessarily needed. However, a warranty or service plan may replace the ToS, in which case the warrant or service plan consent is provided to the the issuer server 112.

At 238, upon receiving the function request message, the issuer server 112 validates the authenticity of the function request message. First, the issuer server 112 validates the function request message using the public key of the switchboard node 110. Then the issuer server 112 authenticates the validation token using the public key of the validation server 114. Next, the issuer server 112 authenticates the client session token using the client ECDH public key, which is embedded in the client session token. Then, the issuer server 112 generates an issuer ECDH public key and an ECDH private key using Elliptic Curve P256. From the issuer ECDH private key and the client ECDH public key, the issuer server 112 generates an encryption secret. Next, the issuer server 112 executes the function requested and generates scope data, detailing the scope of the function executed. The requested function is found in the node session token that is within the validation token. The issuer server 112 also logs completion of the request along with the user's ToS consent (or warranty or service contract acceptance) timestamp. Completion of the function may include authorizing the transaction to be accepted at the merchant.

The scope data is encrypted using the encryption secret. A scope data token is then generated by the issuer server 112, the scope data token containing the encrypted scope data and the issuer's ECDH public key, and the scope data token is signed using the issuer's ECDH private key. The scope data token contains the validation token, which contains the client request token, which contains the node session token, which contains the client session token so that the merchant server 108 can later associate the response to its original request and verify each actor of the request. At 240, the issuer server 112 returns the scope data token to the switchboard node 110.

At 242, the switchboard node 110 accepts the returned encrypted result (e.g., the scope data token) from the issuer server 112 and forwards the encrypted function result to the merchant server 108. The message forwarded from the switchboard node 110 to the merchant server 108 can include the encrypted result indicating that the function was performed (e.g., approval of the transaction from the issuer), the merchant ECDH private key ID, issuer ECDH public key, validation token, node session token, and the client session token.

At 244, the merchant server 108 then unwraps and verifies the different JWT tokens. First, the merchant server 108 verifies the scope data token using the issuer ECDH public key, then the merchant server 108 extracts the validation token from the scope data token and verifies the validation token using the validator public key. Next, the merchant server 108 extracts the node session token from the validation token and verifies the node session token using a node ECDH public key shared with the merchant server 108 by the switchboard node 110. Next, the merchant server 108 extracts the client session token from the node session token and verifies the client session token using the client ECDH public key.

Still at 244, the merchant server 108 communicates with the client key store described above, to retrieve the client ECDH private key using the client session token. The client ECDH private key is then removed from cache in the client key store using the client session token, and the client key store returns the client ECDH private key back to the merchant server 108. Next, the merchant server 108 computes the encryption secret using the client ECDH private key and the issuer ECDH public key (e.g., the issuer ECDH public key is embedded in the function result). Once the merchant server 108 computes the encryption secret, the scope data token is decrypted using the encryption secret to obtain the function result. In the example of the transaction, the function result may indicate that the issuer server 112 has approved or denied the transaction, at which case, the merchant server 108 will also approve or deny the transaction accordingly.

The merchant server 108 uses that data to continue its application business logic. For example, at 246, the transaction has been approved by the issuer, the merchant server 108 sends a message to the user device 104 to finalize the transaction. In some other embodiments, the merchant server 108 completes creation of a user account or rewards account. In some other embodiments, the merchant server 108 establishes a VPN connection for the user device 104, or performs any other action described herein.

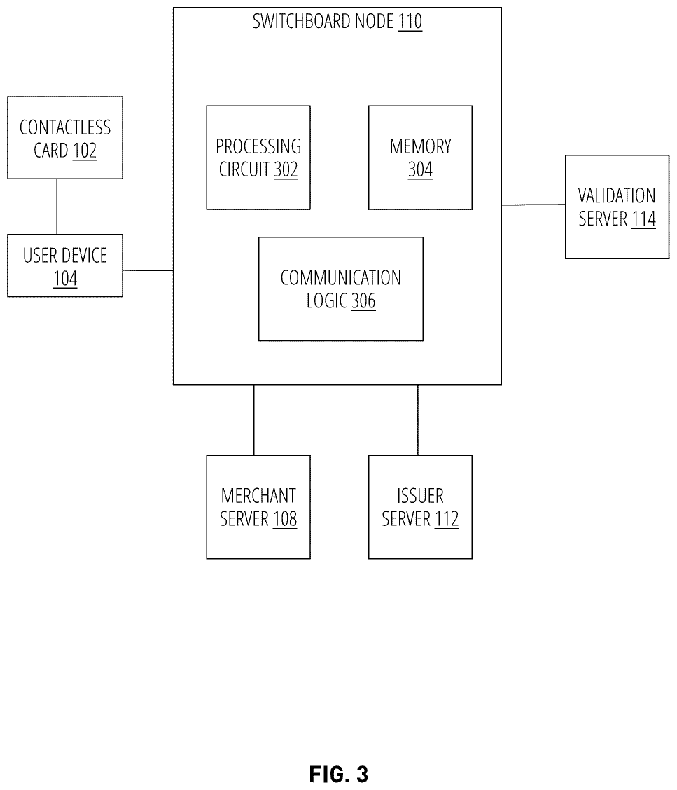

FIG. 3 includes a block diagram of the switchboard node 110 providing more details of the components thereof. FIG. 3 further includes some of the components described in FIG. 1 to show how the switchboard node 110 communicates with the various components in some embodiments. FIG. 3 provides one possible implementation of the process for performing card functions in a computer environment. In some embodiments, the switchboard node 110 comprises a processing circuit 302 and a memory 304. In some embodiments, the memory 304 includes instructions which when executed by the processing circuit 302, cause the processing circuit 302 to perform various operations described herein. For example, in some embodiments, the processing circuit 302 is caused to receive, from a user device 104, a request for a first validation session, the first validation session being associated with a function request from a user account associated with a contactless card 102. The switchboard node 110 is configured to use communication logic 306 to receive and transmit data and messages to the devices described herein.

In some other embodiments, the processing logic 302 receives the request for the first validation session from the merchant server 108. For example, the user device 104 can be using a mobile application associated with the merchant (e.g., a frontend mobile application to the merchant server's backend), and the merchant server 108 can act as the backend to the mobile application operating on the user device 104. The merchant server 108 as the backend device can receive a request from the user device, via the application, to perform a function, and then the merchant server 108 sends the request for the first validation session to the switchboard node 110.

In some embodiments, the processing circuit 302 is caused to establish the first validation session and, as part of establishing the first validation session, generate a unique nonce associated with the first validation session to distinguish the first validation session from any other validation sessions. In some embodiments, the processing circuit 302 is caused to transmit the nonce to the user device 104. The user device 104 is to send the nonce to the contactless card 102 during a near field near-field communication (NFC) exchange between the user device 104 and the contactless card 102. The contactless card 102 is to send the encrypted data to the user device 104 during the NFC exchange.

In some embodiments, the switchboard node 110 is caused to receive a reply from the user device 104, the reply comprising encrypted data from the contactless card 102 and the nonce to indicate the encrypted data is associated with the first validation session. In some embodiments, the switchboard node 110 is caused to transmit the encrypted data to a validation server 114 to validate the encrypted data. Next, the switchboard node 110 is caused to receive, from the validation server 114, an indication that the encrypted data has been validated, the indication including a validation token. The processing circuit 302 is caused to transmit, to an issuer server 112, the validation token along with instructions to complete a function associated with the function request.

In some embodiments, as part of establishing the first validation session, the processing circuit 302 is further caused to transmit a session token signed with a switchboard node private key and a terms of service (ToS) acknowledgement request to the user device 104, wherein the nonce is contained within the session token. The processing circuit 302 is further caused to receive, from the user device 104, a message indicating the ToS are accepted by a user of the user account.

In some embodiments, the processing circuit 302 is further caused to initiate a key negotiation between the issuer server 112 and a merchant server 108 associated with the function request, wherein the issuer server 112 and the merchant server 108 are configured to exchange keys to decrypt messages communicated therebetween. In some embodiments, the processing circuit 302 is further caused to receive confirmation from the issuer server 112 that the function has been completed; and send the confirmation to the merchant server 108 that the function has been completed.

In some embodiments, the function request described above includes at least one selected from the group of: a request to perform an autofill function; a request to execute or approve a transaction; a request to login in to an account; a request to actuate a controller; and a request to establish a virtual private network (VPN) or any other suitable function to be performed between the issuer server 112 and the merchant server 108.

In embodiments, more than one switchboard node 110 may be provided in a network of nodes, as shown in FIG. 9 below. In this case, the nodes may be configured to synchronize their states with each other so that the network of nodes operates in a consistent state across operators. For example, node operators can enroll new issuers and clients or merchant servers 108. Issuer servers 112 and validation servers 114 may only read data. Some of the shared data between the switchboard nodes 110 can include the following key/value associations: client ID to key, client ID to allowed functions, client ID to merchant hostname, node ID to public key, issuer ID to validator hostname, issuer ID to issuer hostname, validator hostname to public key, and function ID to terms of service.

As clients interact with the switchboard nodes 110, the switchboard nodes 110 will log those events to a metrics server (not show) that will also stream those events to a centralized aggregator (e.g., a server) to monitor overall network health. Possible types of reports can include tap metrics per partner or merchant, terms of service acceptance, and network health across partners.

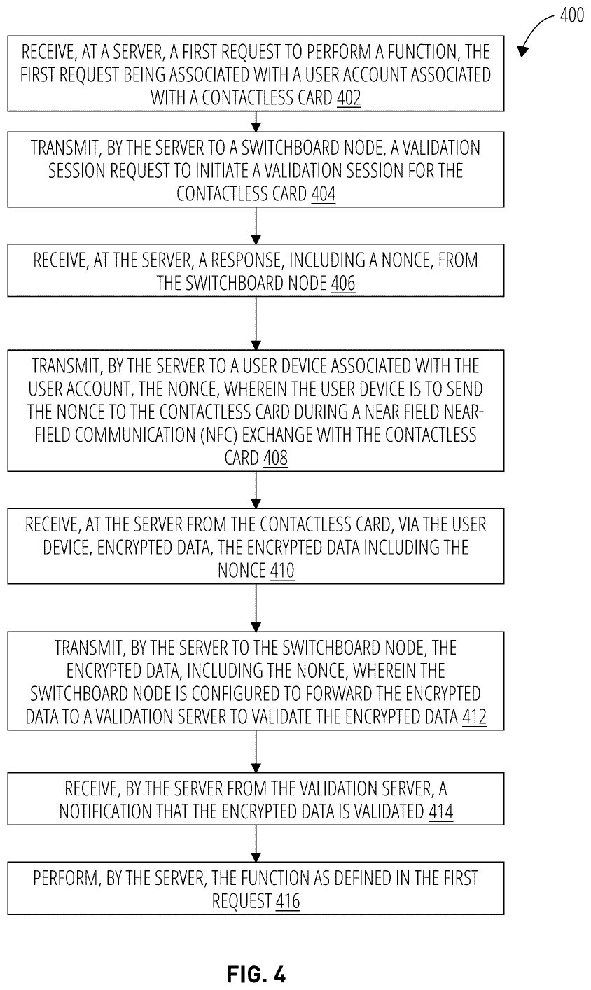

FIG. 4 is a flow chart illustrating some steps in an example method 400 for performing card functions according to some embodiments of the present disclosure. As shown at block 402, the method 400 includes receiving, at a server, a first request to perform a function, the first request being associated with a user account associated with a contactless card. As shown at block 404, the method 400 includes transmitting, by the server to a switchboard node, a validation session request to initiate a validation session for the contactless card. As shown at block 406, the method 400 includes receiving, at the server, a response, including a nonce, from the switchboard node.

As shown at block 408, the method 400 includes transmitting, by the server to a user device associated with the user account, the nonce, wherein the user device is to send the nonce to the contactless card during a near field near-field communication (NFC) exchange with the contactless card. As shown at block 410, the method 400 includes receiving, at the server from the contactless card, via the user device, encrypted data, the encrypted data including the nonce. As shown at block 412, the method 400 includes transmitting, by the server to the switchboard node, the encrypted data, including the nonce, wherein the switchboard node is configured to forward the encrypted data to a validation server to validate the encrypted data. As shown at block 414, the method 400 includes receiving, by the server from the validation server, a notification that the encrypted data is validated. As shown at block 416, the method 400 includes performing, by the server, the function as defined in the first request.

In some embodiments, the nonce is an identifier that is unique to the validation session and the nonce differentiates the validation session from other validation sessions granted by the switchboard node. In some embodiments, the switchboard node is a server operating within a switching network configured to receive at least validation session requests and encrypted data, respond to the validation session requests, and forward the encrypted data to an appropriate validation server configured to validate the encrypted data.

In some embodiments, the method 400 further comprises receiving, at the server from the switchboard node, a request to negotiate with the issuer server to generate a temporary key. In some embodiments, the method 400 further comprises negotiating, by the server, with the issuer server to generate an Elliptic-curve Diffie-Hellman (ECDH) public/private key pair, the temporary key including the public/private key pair and sending, by the server, the public key to the issuer server.

In some embodiments, the confirmation received from the issuer server is encrypted using the ECDH public key by the issuer server, and the method further comprises decrypting, by the server, the encrypted confirmation using the private key. In some embodiments, the response from the switchboard node includes terms of service for the function and a terms of service version identifier, and the method further comprises sending, by the server, the terms of service to the user device; and receiving, by the server from the user device, a message indicating that the terms of service have been accepted. In some embodiments, the first request to perform the function includes at least one selected from the group of: a request to perform an autofill function; a request to execute a transaction; a request to login in to an account; a request to actuate a controller; and a request to establish a virtual private network (VPN).

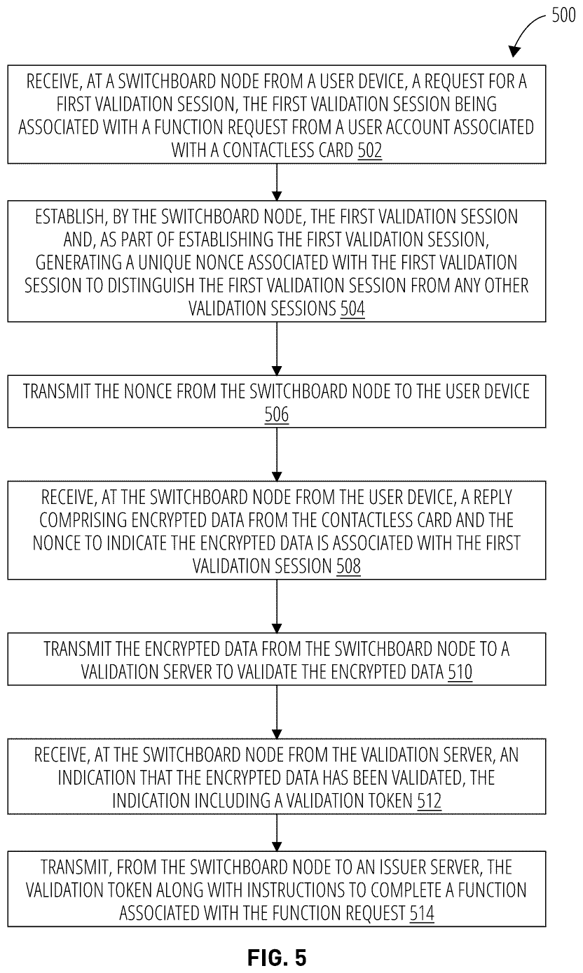

FIG. 5 is a flow chart illustrating some steps in another example method 500 for performing card functions according to some embodiments of the present disclosure. As shown at block 502, the method 500 includes receiving, at a switchboard node from a user device, a request for a first validation session, the first validation session being associated with a function request from a user account associated with a contactless card. As shown at block 504, the method 500 includes establishing, by the switchboard node, the first validation session and, as part of establishing the first validation session, generating a unique nonce associated with the first validation session to distinguish the first validation session from any other validation sessions. As shown at block 506, the method 500 includes transmitting the nonce from the switchboard node to the user device. As shown at block 508, the method 500 includes receiving, at the switchboard node from the user device, a reply comprising encrypted data from the contactless card and the nonce to indicate the encrypted data is associated with the first validation session. As shown at block 510, the method 500 includes transmitting the encrypted data from the switchboard node to a validation server to validate the encrypted data. As shown at block 512, the method 500 includes receiving, at the switchboard node from the validation server, an indication that the encrypted data has been validated, the indication including a validation token. As shown at block 514, the method 500 includes transmitting, from the switchboard node to an issuer server, the validation token along with instructions to complete a function associated with the function request.

In some embodiments, as part of establishing the first validation session, the method further comprises the switchboard node transmitting a session token signed with a switchboard node private key and a terms of service (ToS) acknowledgement request to the user device, wherein the nonce is contained within the session token. In some embodiments, the method 500 further includes receiving, from the user device, a message indicating the terms of service are accepted by a user of the user account. In some embodiments, the method 500 further includes initiating a key negotiation between the issuer server and a merchant server associated with the function request, wherein the issuer server and the merchant server are configured to exchange keys to decrypt messages communicated therebetween.

In some embodiments, the method 500 further includes receiving confirmation from the issuer server that the function has been completed; and sending the confirmation to the merchant server that the function has been completed. In some embodiments, the user device is to send the nonce to the contactless card during a near field near-field communication (NFC) exchange between the user device and the contactless card; and wherein the contactless card is to send the encrypted data to the user device during the NFC exchange. In some embodiments, the function request includes at least one selected from the group of: a request to perform an autofill function; a request to execute or approve a transaction; a request to login in to an account; a request to actuate a controller; and a request to establish a virtual private network (VPN).

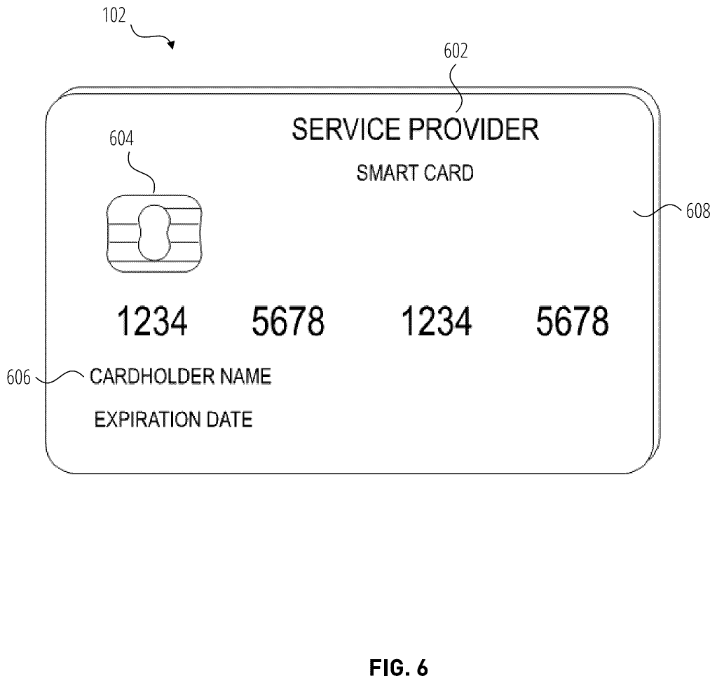

FIG. 6 illustrates an example configuration of a contactless card 102, which may include a contactless card, a payment card, such as a credit card, debit card, or gift card, issued by a service provider as displayed as service provider indicia 602 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 608, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

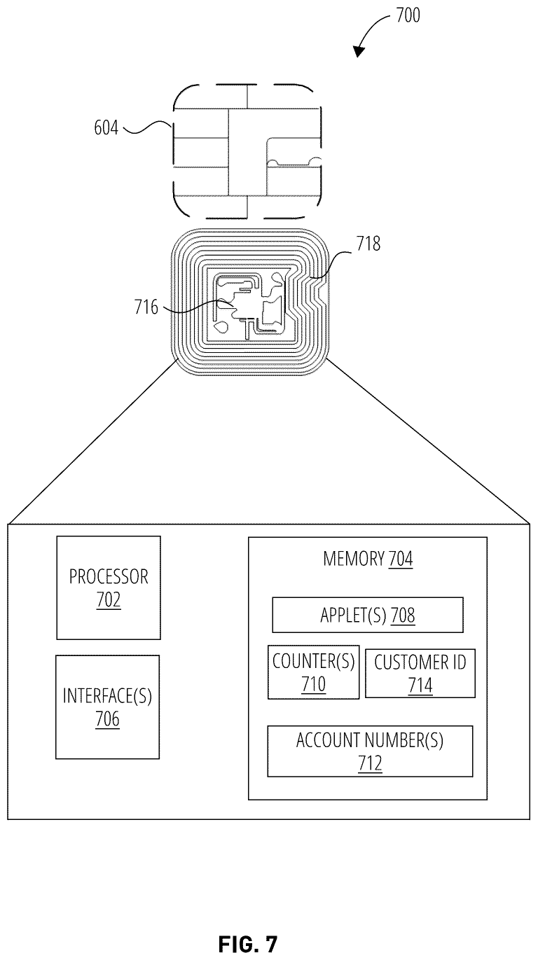

The contactless card 102 may also include identification information 606 displayed on the front and/or back of the card, and a contact pad 604. The contact pad 604 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 7. These components may be located behind the contact pad 604 or elsewhere on the substrate 608, e.g. within a different layer of the substrate 608, and may electrically and physically coupled with the contact pad 604. The contactless card 102 may also include a magnetic strip or tape, which may be located on the back of the card (not shown in FIG. 6). The contactless card 102 may also include a Near-Field Communication (NFC) device coupled with an antenna capable of communicating via the NFC protocol. Embodiments are not limited in this manner.

As illustrated in FIG. 7, the contact pad 604 of contactless card 102 may include processing circuitry 716 for storing, processing, and communicating information, including a processor 702, a memory 704, and one or more interface(s) 706. It is understood that the processing circuitry 716 may contain additional components, including processors, memories, error and parity/CRC checkers, data encoders, anticollision algorithms, controllers, command decoders, security primitives and tamperproofing hardware, as necessary to perform the functions described herein.

The memory 704 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 704 may be encrypted memory utilizing an encryption algorithm executed by the processor 702 to encrypted data.

The memory 704 may be configured to store one or more applet(s) 708, one or more counter(s) 710, a customer identifier 714, and the account number(s) 712, which may be virtual account numbers. The one or more applet(s) 708 may comprise one or more software applications configured to execute on one or more contactless cards, such as a Java® Card applet. However, it is understood that applet(s) 708 are not limited to Java Card applets, and instead may be any software application operable on contactless cards or other devices having limited memory. The one or more counter(s) 710 may comprise a numeric counter sufficient to store an integer. The customer identifier 714 may comprise a unique alphanumeric identifier assigned to a user of the contactless card 102, and the identifier may distinguish the user of the contactless card from other contactless card users. In some examples, the customer identifier 714 may identify both a customer and an account assigned to that customer and may further identify the contactless card 102 associated with the customer's account. As stated, the account number(s) 712 may include thousands of one-time use virtual account numbers associated with the contactless card 102. An applet(s) 708 of the contactless card 102 may be configured to manage the account number(s) 712 (e.g., to select an account number(s) 712, mark the selected account number(s) 712 as used, and transmit the account number(s) 712 to a mobile device or a user device 104 for autofilling by an autofilling service.

In some embodiments, the memory 704 can include (e.g., have stored therein) the data from the fields shown in FIG. 7 and/or FIG. 12. The processor 702 can then use the data from the fields to generate the message 1200 as described above. The message 1200 from FIG. 12 includes the encrypted data sent from the card to the switchboard node 110 and then forwarded to the validation server 114, as described herein.

The processor 702 and memory elements of the foregoing exemplary embodiments are described with reference to the contact pad 604, but the present disclosure is not limited thereto. It is understood that these elements may be implemented outside of the contact pad 604 or entirely separate from it, or as further elements in addition to processor 702 and memory 704 elements located within the contact pad 604.

In some examples, the contactless card 102 may comprise one or more antenna(s) 718. The one or more antenna(s) 718 may be placed within the contactless card 102 and around the processing circuitry 716 of the contact pad 604. For example, the one or more antenna(s) 718 may be integral with the processing circuitry 716 and the one or more antenna(s) 718 may be used with an external booster coil. As another example, the one or more antenna(s) 718 may be external to the contact pad 604 and the processing circuitry 716.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 718, processor 702, and/or the memory 704, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 708 may be added to contactless cards to provide a one-time password (OTP) for multifactor authentication (MFA) in various mobile application-based use cases. Applet(s) 708 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 708 may be configured to encode the OTP as an NDEF type 4 well known type text tag. In some examples, NDEF messages may comprise one or more records. The applet(s) 708 may be configured to add one or more static tag records in addition to the OTP record.

In some examples, the one or more applet(s) 708 may be configured to emulate an RFID tag. The RFID tag may include one or more polymorphic tags. In some examples, each time the tag is read, different cryptographic data is presented that may indicate the authenticity of the contactless card. Based on the one or more applet(s) 708, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 710 may be configured to increment. In some examples, each time data from the contactless card 102 is read (e.g., by a mobile device), the counter(s) 710 is transmitted to the server for validation and determines whether the counter(s) 710 are equal (as part of the validation) to a counter of the server.

The one or more counter(s) 710 may be configured to prevent a replay attack. For example, if a cryptogram has been obtained and replayed, that cryptogram is immediately rejected if the counter(s) 710 has been read or used or otherwise passed over. If the counter(s) 710 has not been used, it may be replayed. In some examples, the counter that is incremented on the card is different from the counter that is incremented for transactions. The contactless card 102 is unable to determine the application transaction counter(s) 710 since there is no communication between applet(s) 708 on the contactless card 102.

In some examples, the counter(s) 710 may get out of sync. In some examples, to account for accidental reads that initiate transactions, such as reading at an angle, the counter(s) 710 may increment but the application does not process the counter(s) 710. In some examples, when the user device 104 is woken up, NFC may be enabled and the user device 104 may be configured to read available tags, but no action is taken responsive to the reads.

To keep the counter(s) 710 in sync, an application, such as a background application, may be executed that would be configured to detect when the mobile user device 104 wakes up and synchronize with the server of a banking system indicating that a read that occurred due to detection to then move the counter(s) 710 forward. In other examples, Hashed One Time Password may be utilized such that a window of mis-synchronization may be accepted. For example, if within a threshold of 10, the counter(s) 710 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 710 increases in the appropriate sequence, then it possible to know that the user has done so.

The key diversification technique described herein with reference to the counter(s) 710, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

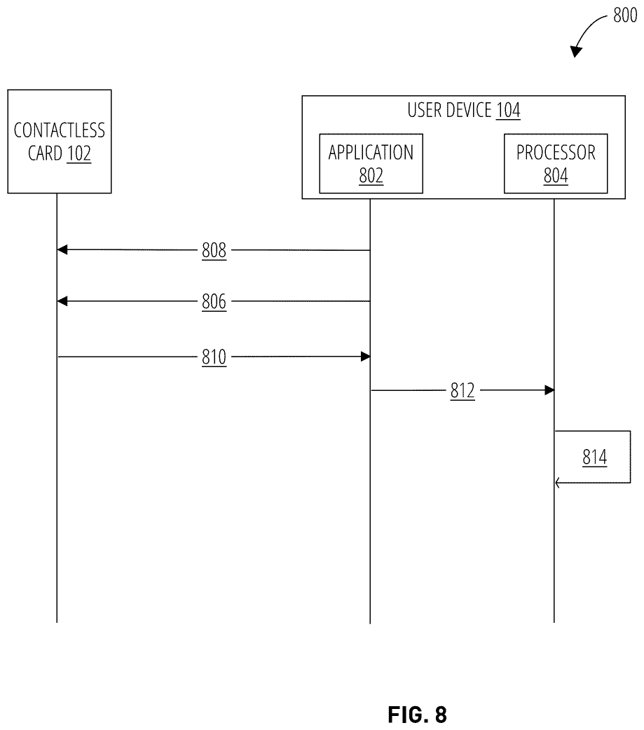

FIG. 8 is a timing diagram illustrating an example sequence for providing the message 1200 or encrypted data described herein from the contactless card 102 to the user device 104. In other words, FIG. 8 provides one example embodiment of an NFC exchange between the contactless card 102 and the user device 104. Sequence flow 800 may include contactless card 102 and user device 104, which may include an application 802 and processor 804.

At line 808, the application 802 communicates with the contactless card 102 (e.g., after being brought near the contactless card 102). Communication between the application 802 and the contactless card 102 may involve the contactless card 102 being sufficiently close to a card reader (not shown) of the user device 104 to enable NFC data transfer between the application 802 and the contactless card 102.

At line 806, after communication has been established between user device 104 and contactless card 102, contactless card 102 generates a message authentication code (MAC) cryptogram. In some examples, this may occur when the contactless card 102 is read by the application 802. In particular, this may occur upon a read, such as an NFC read, of a near field data exchange (NDEF) tag, which may be created in accordance with the NFC Data Exchange Format. For example, a reader application, such as application 802, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 802 may be configured to transmit a request to contactless card 102, the request comprising an instruction to generate a MAC cryptogram.

At line 810, the contactless card 102 sends the MAC cryptogram to the application 802. In some examples, the transmission of the MAC cryptogram occurs via NFC, however, the present disclosure is not limited thereto. In other examples, this communication may occur via Bluetooth, Wi-Fi, or other means of wireless data communication. At line 812, the application 802 communicates the MAC cryptogram to the processor 804.

At line 814, the processor 804 verifies the MAC cryptogram pursuant to an instruction from the application 802. For example, the MAC cryptogram may be verified, as explained below. In some examples, verifying the MAC cryptogram may be performed by a device other than user device 104, such as a server of a banking system in data communication with the user device 104. For example, processor 804 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 9 illustrates an example switchboard system 900 in accordance with the embodiments discussed herein. The system 900 includes additional devices and systems configured to enable contactless card issuers to tap-to-card services. Specifically, system 900 enables any number of issuer systems to provide card services to their clients through a switching fabric, i.e., the switchboard system 900 in a secure and safe manner. The description herein provides more details on how the nonce is generated and how the switchboard node 110 from FIG. 1 and FIGS. 2A and 2B communicates with the merchant server 108 and the validation server 114. In FIG. 9, the merchant server 108 is referred to as merchant system 922, and the validation server 114 is referred to as validation system 924. The switchboard node 110 is referred to as switchboard node 904.

In embodiments, the switchboard system includes one or more switchboard nodes 904 configured to perform routing operations. Each switchboard node 904 may include a session and nonce generator 906, a message router 908, an authentication 910, an operation data 912 store, and a metrics store 914. Further, each of the nodes may be configured the same and share configurations, but each switchboard node 904 may independently process and route messages and requests to the appropriate systems, such as the merchant systems and issuer systems. Each of the switchboard nodes 904 is configured to act as a broker of trust between an issuer system, the merchant system 922, and/or validation system 924, for example. Each switchboard node 904 is configured to route each message to the correct issuer system while maintaining data security. For example, a switchboard node 904 may route a message between an issuer system and a merchant system while the node cannot access the private data in the message.

The switchboard system 900 may be configured as a server system with a collection of hardware, software, and networking components that work together to provide client services. Hardware components may include one or more server computers, storage devices, and network adapters. The server computers are configured to run server applications, such as those executable on each of the switchboard nodes 904. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

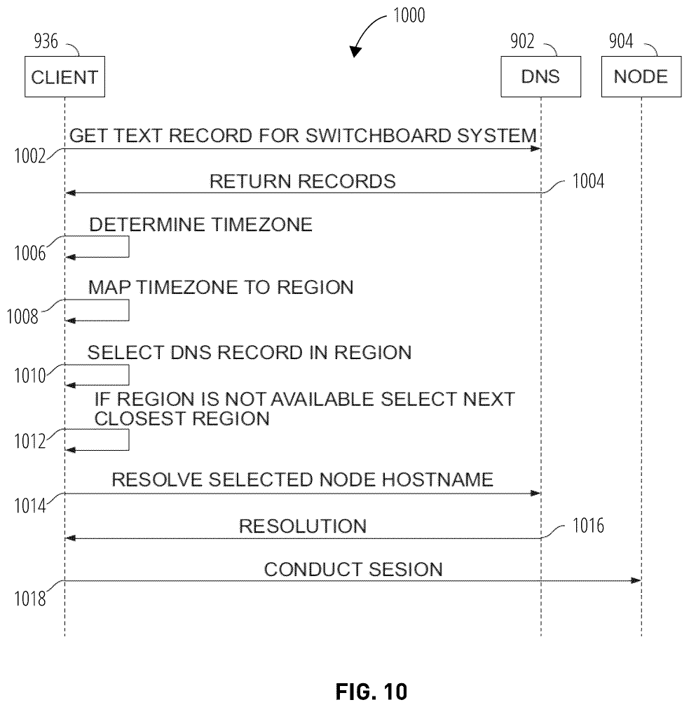

In some embodiments, the switchboard nodes 904 may operate in a cloud-based computing environment, e.g., a collection of hardware, software, and networking components that enable the delivery of cloud computing services. The switchboard nodes 904 and the computing services are delivered over the Internet and can be accessed from anywhere in the world with an Internet connection. In embodiments, client 936 may access a switchboard node 904 through DNS 902 or Domain Name System (DNS). The DNS 902 is a hierarchical and distributed naming system for computers, services, and other resources connected to the Internet or other networks. It associates various information with domain names assigned to each registered participant. In one example, the DNS 902 may translate a name known to software executing on a client 936 to route data to one or more of switchboard node 904 of the switchboard system. In embodiments, the DNS 902 may generate a number, such as an Internet Protocol (IP) address, an address record (A-record), or another Hostname (C-name record). FIG. 10 illustrates one example sequence 1000 for a client to identify and resolve an identifier for one of the switchboard nodes 904 of the switchboard system. At a high level, the DNS 902 translates known domain names to numerical Internet Protocol (IP) addresses needed for locating and identifying computer services and devices with the underlying network protocols. Clients use the global DNS system to select the best node to use, as discussed in sequence 1000.

In embodiments, a client 936 communicates with the switchboard system to perform one or more of the partner services 932, such as conducting a transaction with a merchant, validating the customer, or other tap-to functions. Once client 936 identifies a switchboard node 904 and resolves an address to communicate with switchboard node 904, client 936 may send one or more messages to switchboard node 904 to authenticate and perform the operation. The switchboard node 904 includes an authentication 910 function that is configured to authenticate the client 936. In embodiments, the client 936 sends a message or authorization request to the switchboard node 904 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

The switchboard node 904 may authorize or authenticate the client 936 or user, and the switchboard node 904 may utilize the additional components, such as the session and nonce session and node generator 906 and message router 908, to perform the operations. Note the validation systems validation system 924 never interact with the merchant systems 922, nor vice versa. The nodes switchboard node 904 brokers all communication.

In embodiments, the switchboard system may utilize a hyper ledger fabric 920 to manage to synchronize the shared operation data 912 and member management across the network. The hyperledger fabric 920 is distributed ledger framework having a permissioned network model that only authorized participants can join the network and access the data that is stored on a ledger.

In embodiments, the hyperledger fabric 920 may be generated by creating one or more sets of peers, an ordering service, and a channel. Once the network is created, system 900 deploys chaincode to the network, or switchboard node 904 is permitted to access the fabric. The chaincode is the code that runs on the blockchain and executes the network control 926 and operation data 912 logic code. Once the chaincode is deployed, each of the switchboard nodes 904 is configured to invoke transactions on the blockchain to add data to the blockchain, e.g., the operational data. A switchboard node 904 or another device can query the ledger to retrieve data. The ledger is a distributed database that stores all the data added to the blockchain.

All switchboard nodes 904 keep an independently verifiable log of their actions that can be transmitted to a centralized aggregator to build a picture of overall network usage. System 900 can manage network operation data and management at a central level and have a centralized view of network use, aggregated and abstracted to the appropriate level.

FIG. 10 illustrates an example sequence 1000 for a client to utilize DNS to resolve and communicate with one or more nodes of a switchboard system. The illustrated sequence 1000 includes a client 936, a DNS 902, and a switchboard node 904. At 1002, the sequence 1002 includes the client 936 sending a request to a default DNS server for a text record switchboard. {domain}. {tld}. The text record may be preconfigured in a client app and/or client SDK. At 1004, the DNS 902 returns one or more records. A DNS record structure may include the following:

| | |
|---|---|
| ● | Root Record: |

| | |
|---|---|
| ◯ | Name: switchboard.{domain}.{tld} |
| ◯ | Type: TXT |
| ◯ | Resolution: |

| | |
|---|---|
| ▪ | {nodename_1}.{operator_a}.{region_i}.switchboard.{domain}.{tld}, |
| ▪ | {nodename_2}.{operator_a}.{region_i}.switchboard.{domain}.{tld}, |
| ▪ | {nodename_1}.{operator_b}.{region_ii}.switchboard.{domain}.{tld}, |
| ▪ | {nodename_2}.{operator_b}.{region_ii}.switchboard.{domain}.{tld}, |
| ▪ | * etc. |

| | |
|---|---|
| ◯ | Used For determining where there are active nodes |

| | |
|---|---|
| ● | Node Record: |

| | |
|---|---|
| ◯ | Name: {nodename}.{operator}.{region}.switchboard.{domain}.{tld} |
| ◯ | Type: A/AAAA or CNAME |
| ◯ | Resolution: Actual node hostname or IP |
| ◯ | Used For: communicating with a switchboard node 904 |

In embodiments, the client 936 may determine the current timezone at 1006. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1008, the client 936 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1010, the client 936 may identify or select a DNS record option returned at 1004 that is in the region. If there are multiple matches, the client 936 may select one at random. If there's no node available in a region, the client 936 may determine and use a data graph of neighboring regions to select a node in the closest region where a node is available at 1012. For example, sa has no node but is connected to na-e where there is a node and so na-e is selected. In some embodiments,

At 1014, the client may resolve a selected node's hostname. In embodiments, the client 936 may automatically resolve the hostname using the client's HTTP request default resolver. At 1016, the DNS 902 may return a result. And at 1018, the client 936 may communicate with a switchboard node 904 and begin the process to interact with the switchboard.

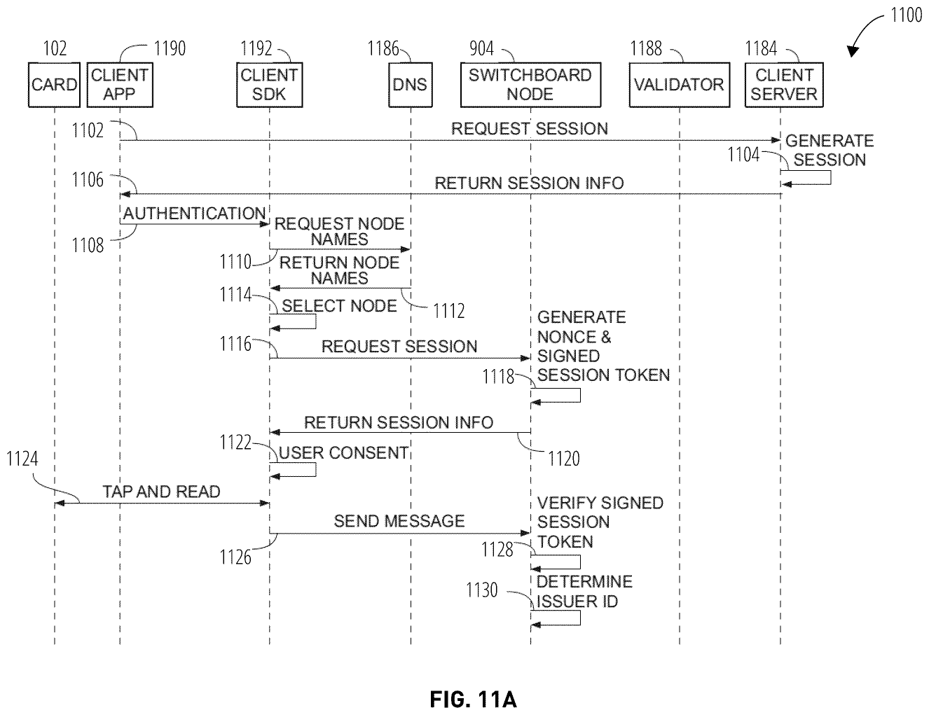

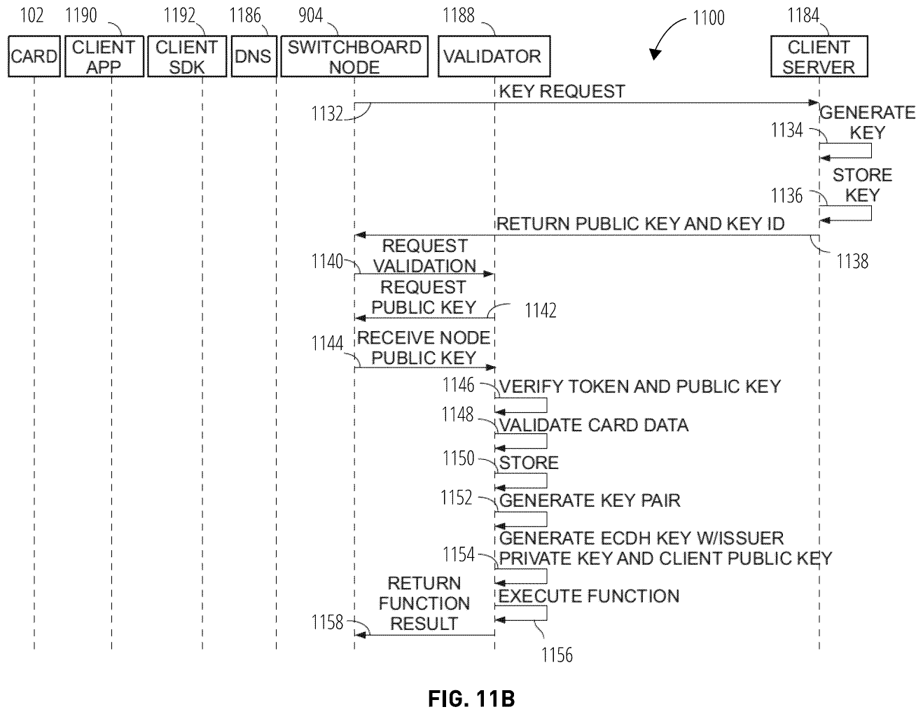

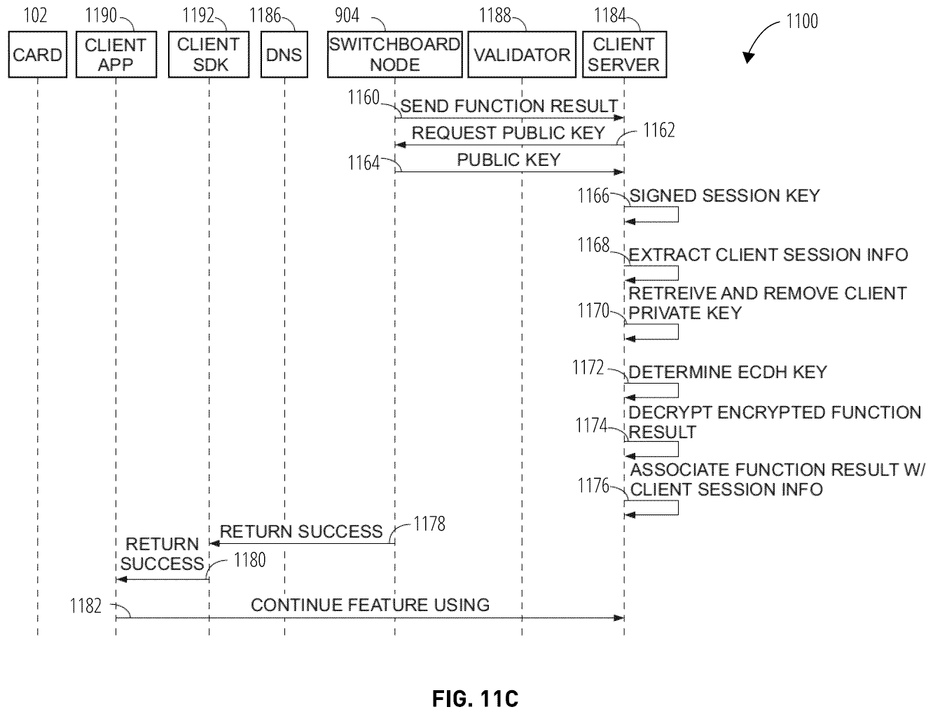

FIG. 11A-FIG. 11C illustrate an example sequence 1100 to perform operations between a contactless card 102 and services provided by a card issuer and/or merchant. The sequence 1100 illustrates another example embodiment of performing card functions in a computing environment, according to the present disclosure. The illustrated sequence 1100 includes actions and communications performed by a contactless card 102, a client 936 including a client app 1190 and a client SDK 1192, a DNS 1186, a switchboard system including one or more switchboard nodes 904, a partner services 932 including a merchant and/or validator 1188, and control services 934 including a client server 1184 or system. In embodiments, the client app 1190 may be any application configured to execute on a client 936, such as a banking app, a merchant app, a social media app, a travel app, a gaming app, a productivity app, an entertainment app, and so forth. In embodiments, the client app 1190 includes a web browser to provide websites and pages. The client app 1190 may include and/or utilize the client SDK 1192, which may be a set of instructions that enable the client app 1190 to communicate with other components of the switchboard system.

In embodiments, as shown in FIG. 11A, at 1102 the client 936 including the client app may send a request and establish a session with a client server 1184 such that a result may be associated with the correct client device or user. The request establishes a relationship between the client device and client server, which may be an issuer server. At 1104, the client server 1184 generates a session and CLIENT SESSION INFORMATION. At 1106, the client server 1184 returns the session information, e.g., the CLIENT SESSION INFORMATION. In embodiments, the CLIENT SESSION INFORMATION may be the Client implementation-specific user session identification information.

At 1108, the client 936 may initiate a contactless card authentication process with the client 936. For example, the client 936 may call a function and/or pass information to the client 936 to initiate authentication via a contactless card 102. At 1110-1114, the client 936 may utilize DNS to identify a node and establish communication with the node. Specifically, at 1110, the client 936 including the client SDK 1192 may send a request for switchboard hostnames, and at 1112 the the DNS 1186 may return information including one or more hostnames. At 1114, the client 936 may determine a switchboard node to communicate. FIG. 10 illustrates an example of a more detailed sequence of the process to establish communication with a switchboard node 904.

At 1116, the client 936 may send a request for a session to the switchboard system 900. In embodiments, the request for a session may be for a function request in the format <FUNCTION REQUEST>. In embodiments, the FUNCTION REQUEST may be the data/function that the client 936 would like to request once a contactless card 102 has been validated. The function could be for any service discussed herein, e.g., authenticate the user, perform a transaction, request autofill data, etc. At 1118, switchboard system 900 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 900 private key. The switchboard system 900 may include a NODE PUBLIC/PRIVATE KEY, which is a keypair used to sign and validate JWTs.

At 1120, the switchboard system 900 may return session information to the client 936. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1122, the client SDK 1192 may determine and/or receive user consent to the terms of service. In one example, the client SDK 1192 captures and records the user consent to <FUNCTION TOS> on <CONSENT DATE> with <TOS VERSION>. The CONSENT DATE may be the timestamp for the user's consent to the TOS.

At 1124, the client 936 exchanges one or more messages with a contactless card. In one example, the exchange may be based on the contactless card being tapped to a client device. In embodiments, the client SDK 1192 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes |
| | | binary data |
| 0F . . . 12 | Session Indicators | 4 bytes of ASCII HEX encoded 2 bytes |
| | | binary data |
| 13 . . . 16 | Control Indicators | 4 bytes of ASCII HEX encoded 2 bytes |
| | | binary data |
| 17 . . . 26 | Update Date | 16 bytes of ASCII HEX encoded 8 |
| | creation Time | bytes binary data - represents 64 bit |
| | | unix timestamp |
| 27 . . . 36 | Update MAC | MAC to protect control indicators - 16 |
| | | bytes of ASCII HEX encoded 8 bytes |
| | | binary data |

The updated MAC may be calculated to protect the control indicators in embodiments. Specifically, The MAC M is determined by calculating a MAC over the 10 bytes of the update data U with the Update MAC Card Key (MCK), as described in FIG. 12, message 1200.

At 1124, the contactless card may generate and provide a message to the client's device including the client SDK 1192. The data in the message may be utilized by the system discussed herein to perform the function requested. One example of the message is illustrated and discussed in FIG. 12, message 1200.

At 1126, the client including the client SDK 1192 may send a message and information to the switchboard system 900. The message may be the message received from the contactless card 102, e.g., message 1200. In addition, the client SDK 1192 may send the consent date, the TOS version, and the signed session token to the switchboard system 900. The switchboard system 900 may utilize the information to ensure the session is valid. At 1128, the switchboard system 900 verifies the signed session token is valid, e.g., is the previously provided signed session token and includes the nonce previously generated and is in the message.

In some embodiments, the switchboard system 900 is configured to determine which issuer system or client-server it should route the message to for processing. At 1130, the switchboard system 900 may determine the issuer ID by extracting it from the message received from the contactless card 102 via the client SDK 1192. As mentioned, the issuer ID identifies the issuer of the contactless card 102.

FIG. 11B continues the sequence 1100 from FIG. 11A. In embodiments, the switchboard system 900 is configured to generate and communicate secure communications with the issuer system, e.g., the client server 1184 and the validator 1188. At 1132, the switchboard system 900 sends a request for a key to the client server 1184. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1134, the client server 1184 generates a portion of the key. In some instances, the client server 1184 may generate half of the ECDH key for encryption/decryption of PII. Specifically, the client server 1184 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1136, the client-server 1184 stores the generated portion of the key in storage. Specifically, the client server 1184 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1184 may return the public key portion to the switchboard system 900 with the KEY ID at 1138. The switchboard system 900 may store the public key portion with the KEY ID for later use, e.g., generation of the ECDH key. At 1140, the switchboard system 900 may request a validation to be performed by the validator 1188. In one example, the switchboard system 900 may send a request validation as Request validation <MESSAGE>, <SIGNED SESSION TOKEN>, <CLIENT EC PUBLIC KEY>, <CONSENT DATE>, and the <TOS VERSION>. The validator 1188 may make an out-of-band request back to the switchboard system 900 for the public key to verify the session at 1142. At 1144, the switchboard system 900 may provide the node's public key, i.e., <NODE PUBLIC KEY>. Further at 1146, the validator 1188 may utilize the node's public key to verify the secure session token.

In embodiments, the validator 1188 may validate the message at 1148. In embodiments, the validator 1188 may perform a number of validations including ensuring the nonce in the message is correct along with additional information, such as the card's unique identifier (pUID), and the counter value (pATC).

At 1150, the validator 1188 may store information associated with the session. For example, validator 1188 may store the <CONSENT DATE> with the <TOS VERSION> and the <PUID>. The validator 1188 may also generate another portion of the key, e.g., the ECDH key. For example, the 1188 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1154, the validator 1188 may generate the complete ECDH key. For example, the validator 1188 generates the <ECDH KEY> from <ISSUER EC PRIVATE KEY> and <CLIENT EC PUBLIC KEY>. The ECDH KEY is the final key generated using ECDH key negotiation.

The validator 1188 may utilize the ECDH KEY to encrypt data for the function. For example, if the validator 1188 validates the message in some instances, the validator 1188 may execute a function request to create a function result and encrypt the result with the ECDH KEY at 1156. For example, the validator 1188 may Execute <FUNCTION REQUEST> to create <FUNCTION RESULT> and encrypt it with the <ECDH KEY>. The function result may be any result based on the requested function, e.g., verification of the card.

At 1158, the validator 1188 may return the function result to the switchboard system 900. In some instances, the function result is returned encrypted. For example, the validator 1188 may return the <ENCRYPTED FUNCTION RESULT> and the <ISSUER EC PUBLIC KEY>.

FIG. 11C continues the sequence 1100 from FIG. 11B. In embodiments, at 1160 the switchboard system 900 sends the function result to the client server 1184 to process the result. In one example, the switchboard system 900 may send the <ENCRYPTED FUNCTION RESULT>, <KEY ID>, <ISSUER EC PUBLIC KEY>, and <SIGNED SESSION TOKEN>. At 1162 and 1164, the client server 1184 may make a request for and receive the public key from the switchboard system 900. In some instances, the exchange may be performed via out-of-band communication channels. The public key for the node may be <NODE PUBLIC KEY>. The public key may be used to verify the sender of the function result, etc. At 1166, the client server 1184 may verify the signed session key with the node's public key <NODE PUBLIC KEY> to verify the sender of the information. At 1168, the client server 1184 may extract client information from the signed session token. For example, the client server 1184 may Extract <CLIENT SESSION INFO> from <SIGNED SESSION TOKEN>, i.e., extracting the client implementation-specific user session identification information.

Further, at 1170, the client server 1184 may retrieve the client's private key with the KEY ID. Specifically, the client server 1184 may get and remove the <CLIENT PRIVATE KEY> from cache using the <KEY ID>. At 1172, the client server 1184 may generate or compute the ECDH key. For example, the client server 1184 may compute the <ECDH KEY> with the <CLIENT PRIVATE KEY>+<ISSUER EC PUBLIC KEY>. The client server 1184 may decrypt the function result with the computed key at 1174. Specifically, the client server 1184 may decrypt the <ENCRYPTED FUNCTION RESULT> with the <ECDH KEY> to determine the <FUNCTION RESULT>. At 1176, the client server 1184 associates the function result with the session.

In embodiments, the switchboard system 908 may return whether the function result was successfully completed or not at 1178 to the client SDK 1192. Further at 1180, the client SDK 1192 may notify the client app 1190 of the result. At 1182, the client app 1190 may utilize the feature. For example, the 1182 may communicate with the client server 1184 to continue the feature using the <CLIENT SESSION INFO> to fetch the redacted <FUNCTION RESULT>.

FIG. 12 illustrates an example of a message 1200 that may be communicated by a contactless card to perform the functions described herein, such as those discussed in any of the figures above, including the description of FIGS. 2A and 2B and FIG. 11A through FIG. 11C. One or more of the fields in message 1200 may also be utilized to route the message 1200 through the switchboard system and perform authentication/validation techniques.

In embodiments, the message 1200 includes an applet version 1202 field, an issuer discretionary indicator 1204 field, an Issuer Identifier 1206 field, a pKey ID 1208 field, a pUID 1210 field, a pATC 1212 field, a nonce 1214 field, and an encrypted cryptogram 1216. The nonce 1214 can include the nonce described above as part of the switchboard node 110 generating the validation session.

In embodiments, the fields may be in plain text or encrypted. For example, the applet version 1202 field may include an applet version in plain text. The applet version indicates which applet version is installed on a contactless card and may be used by the other systems to determine how to process the message 1200 when communicated. For example, different Applet versions require different validation logic, e.g., an older message may be routed through the issuer system to perform various operations for validation, while a newer message may be routed through the switchboard system to perform the various operations, including validation.

In embodiments, the message 1200 includes an issuer discretionary indicator 1204 field that may include issuer data and set at the time of personalization. In addition, the message 1200 includes an Issuer Identifier 1206 field that may include a unique ID assigned to the entity issuing the card, e.g., the issuer. For example, when joining the system, each issuer may be assigned a unique identifier during an onboarding operation. The issuer ID can be used by the switchboard system 908 to route a message and its contents to the appropriate services that are associated with that particular issuer.

In embodiments, the message 1200 includes a pKey ID 1208 field. In some instances, the pKey ID 1208 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1200 may include a pUID 1210 field, including a card unique identifier assigned to the contactless card at personalization time. The pUID 1210 field data may be a combination of alphanumeric characters used to identify each card and associated with a user uniquely.

In embodiments, the message 1200 includes a pATC 1212 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1200 is created, a new session key is derived and utilized to generate one or more portions of the message 1200. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1200 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00′] with a Data Encryption Key (DEK) or UDK. Further, the contactless card 102 computes SKR by encrypting [ATC[2]∥ATC[3]∥‘0F’∥‘00’∥‘00∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES⁻¹(ASKR) [B], where DES⁻¹ is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1]XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1]XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes) ∥‘80’∥‘00 00 00 00 00’]. For the calculations, the data may be divided into two separate portions. Specifically, the data U is broken into two blocks of 8 bytes of data, whereU=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

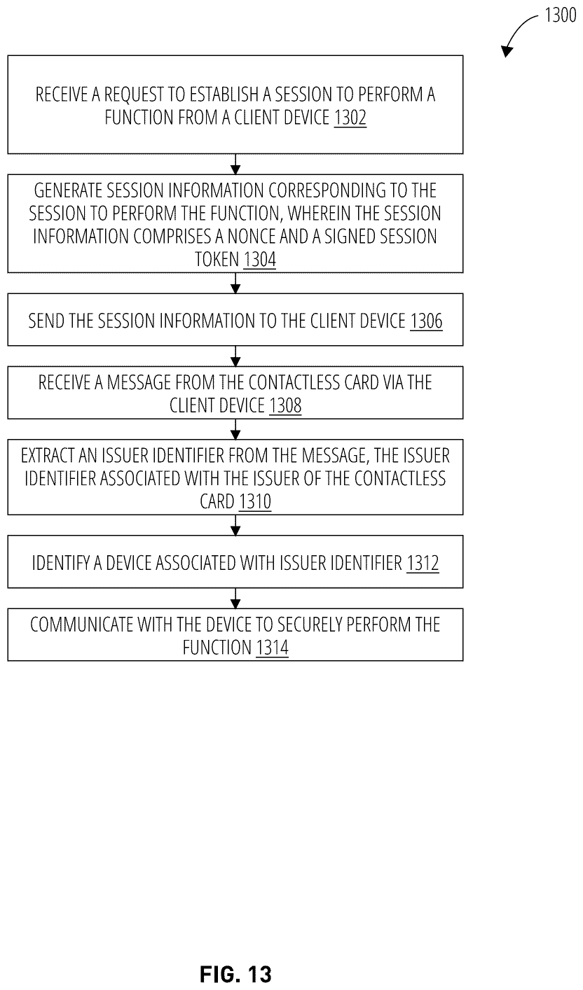

FIG. 13 illustrates an example of method 1300 in accordance with embodiments discussed herein. In block 1302, the method 1300 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1304, the method 1300 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1306, method 1300 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 12).

In block 1308, method 1300 includes receiving, by the node, a message from the contactless card via the client device. The message may be generated by the contactless card. FIG. 12 illustrates one example of a message 1200. In some embodiments, the node verifies the message. For example, the node may verify a nonce in the message and a signed session token.

In block 1310, method 1300 extracts an issuer identifier from the message by the node, the issuer identifier associated with the issuer of the contactless card. In some instances, the issuer identifier may be in a plaintext format.

In block 1312, method 1300 identifies, by the node, a device associated with the issuer identifier. For example, the node may perform a lookup to determine a server associated with the issuer identifier and the function to be performed.

In block 1314, method 1300 communicates, by the node, with the device to securely perform the function.

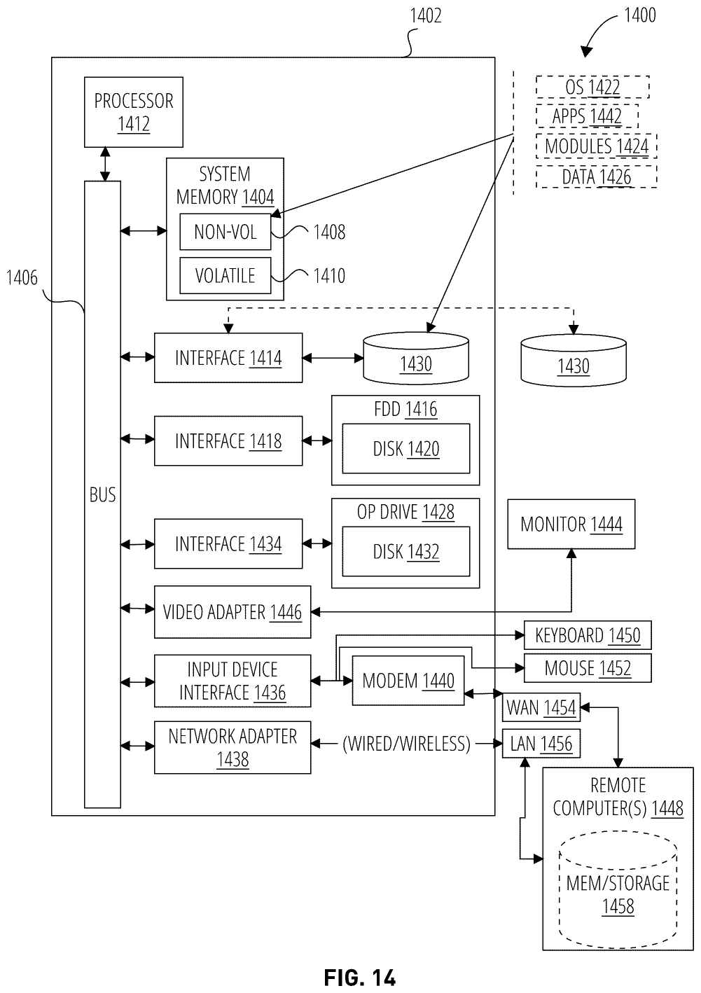

FIG. 14 illustrates an embodiment of an exemplary computer architecture 1400 suitable for implementing various embodiments as previously described. In one embodiment, the computer architecture 1400 may include or be implemented as part of one or more systems or devices discussed herein. For example, the computer architecture 1400 includes components that can implement one or more of the user device 104, switchboard node 110, merchant server 108, issuer server 112, validation server 114, and any other computing device described in this application.

As used in this application, the terms “system” and “component” are intended to refer to a computer-related entity, either hardware, a combination of hardware and software, software, or software in execution, examples of which are provided by the exemplary computer architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bidirectional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 1400 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 1500.

As shown in FIG. 14, the computer architecture 1400 includes a processor 1412, a system memory 1404 and a system bus 1406. The processor 1412 can be any of various commercially available processors or processor circuits.

The system bus 1406 provides an interface for system components including, but not limited to, the system memory 1404 to the processor 1412. The system bus 1406 can be any of several types of bus structure that may further interconnect to a memory bus (with or without a memory controller), a peripheral bus, and a local bus using any of a variety of commercially available bus architectures. Interface adapters may connect to the system bus 1406 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1400 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1404 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1404 can include non-volatile 1408 and/or volatile 1410. A basic input/output system (BIOS) can be stored in the non-volatile 1408.

The computer 1402 may include various types of computer-readable storage media in the form of one or more lower speed memory units, including an internal (or external) hard disk drive 1430, a magnetic disk drive 1416 to read from or write to a removable magnetic disk 1420, and an optical disk drive 1428 to read from or write to a removable optical disk 1432 (e.g., a CD-ROM or DVD). The hard disk drive 1430, magnetic disk drive 1416 and optical disk drive 1428 can be connected to system bus 1406 the by an HDD interface 1414, and FDD interface 1418 and an optical disk drive interface 1434, respectively. The HDD interface 1414 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1408, and volatile 1410, including an operating system 1422, one or more applications 1442, other program modules 1424, and program data 1426. In one embodiment, the one or more applications 1442, other program modules 1424, and program data 1426 can include, for example, the various applications and/or components of the systems discussed herein.

A user can enter commands and information into the computer 1402 through one or more wire/wireless input devices, for example, a keyboard 1450 and a pointing device, such as a mouse 1452. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1412 through an input device interface 1436 that is coupled to the system bus 1406 but can be connected by other interfaces such as a parallel port, IEEE 1394 serial port, a game port, a USB port, an IR interface, and so forth.

A monitor 1444 or other type of display device is also connected to the system bus 1406 via an interface, such as a video adapter 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wire and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all the elements described relative to the computer 1402, although, for purposes of brevity, only a memory and/or storage device 1458 is illustrated. The logical connections depicted include wire/wireless connectivity to a local area network 1456 (LAN) and/or larger networks, for example, a wide area network 1454 (WAN). Such LAN and WAN networking environments are commonplace in offices and companies, and facilitate enterprise-wide computer networks, such as intranets, all of which may connect to a global communications network, for example, the Internet.

When used in a local area network 1456 networking environment, the computer 1402 is connected to the local area network 1456 through a wire and/or wireless communication network interface or network adapter 1438. The network adapter 1438 can facilitate wire and/or wireless communications to the local area network 1456, which may also include a wireless access point disposed thereon for communicating with the wireless functionality of the network adapter 1438.

When used in a wide area network 1454 networking environment, the computer 1402 can include a modem 1440, or is connected to a communications server on the wide area network 1454 or has other means for establishing communications over the wide area network 1454, such as by way of the Internet. The modem 1440, which can be internal or external and a wire and/or wireless device, connects to the system bus 1406 via the input device interface 1436. In a networked environment, program modules depicted relative to the computer 1402, or portions thereof, can be stored in the remote memory and/or storage device 1458. It will be appreciated that the network connections shown are exemplary and other means of establishing a communications link between the computers can be used.

The computer 1402 is operable to communicate with wire and wireless devices or entities using the IEEE 1102 family of standards, such as wireless devices operatively disposed in wireless communication (e.g., IEEE 1102.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

The various elements of the devices as previously described with reference to FIGS. 1-14 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine cause the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, the term “merchant” is not limited to a particular merchant or type of merchant. Rather, the term includes any type of merchant, vendor, or other entity involved in activities where products or services are sold or otherwise provided.

As used herein, the term “bank” is not limited to a financial institution or other type of entity. Rather, the term includes any type of financial institution, business or industrial organization, or other entity involved in the handling or processing of transactions.

As used herein, the term “account” is not limited to a particular type of account. Rather, it is understood that the term “account” can refer to a variety of accounts, including without limitation, a financial account (e.g., a credit account, a debit account, etc.), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving, at a server, a first request to perform a function, the first request being associated with a user account associated with a contactless card;
transmitting, by the server to a switchboard node, a validation session request to initiate a validation session for the contactless card;
receiving, at the server, a response, including a nonce, from the switchboard node;
transmitting, by the server to a user device associated with the user account, the nonce, wherein the user device is to send the nonce to the contactless card during a near field near-field communication (NFC) exchange with the contactless card;
receiving, at the server from the contactless card, via the user device, encrypted data, the encrypted data including the nonce;
transmitting, by the server to the switchboard node, the encrypted data, including the nonce, wherein the switchboard node is configured to forward the encrypted data to a validation server to validate the encrypted data;
receiving, by the server from the validation server, a notification that the encrypted data is validated; and
performing, by the server, the function as defined in the first request.

2. The method of claim 1, wherein:
the nonce is an identifier that is unique to the validation session; and
the nonce differentiates the validation session from other validation sessions granted by the switchboard node.

3. The method of claim 1, wherein the switchboard node is a server operating within a switching network configured to receive at least validation session requests and encrypted data, respond to the validation session requests, and forward the encrypted data to an appropriate validation server configured to validate the encrypted data.

4. The method of claim 1, further comprising:
receiving, at the server from the switchboard node, a request to negotiate with the issuer server to generate a temporary key;
negotiating, by the server, with the issuer server to generate an Elliptic-curve Diffie-Hellman (ECDH) public/private key pair, the temporary key including the public/private key pair; and
sending, by the server, the public key to the issuer server.

5. The method of claim 4, wherein the confirmation received from the issuer server is encrypted using the ECDH public key by the issuer server, and the method further comprises:
decrypting, by the server, the encrypted confirmation using the private key.

6. The method of claim 1, wherein the response from the switchboard node includes terms of service for the function and a terms of service version identifier; and
wherein the method further comprises:
sending, by the server, the terms of service to the user device; and
receiving, by the server from the user device, a message indicating that the terms of service have been accepted.

7. The method of claim 1, wherein the first request to perform the function includes at least one selected from the group of:
a request to perform an autofill function;
a request to execute a transaction;
a request to login in to an account;
a request to actuate a controller; and
a request to establish a virtual private network (VPN).

8. A switchboard node comprising:
a processing circuit; and
a memory containing instructions which when executed by the processing circuit, cause the processing circuit to:
receive, from a user device, a request for a first validation session, the first validation session being associated with a function request from a user account associated with a contactless card;
establish the first validation session and, as part of establishing the first validation session, generate a unique nonce associated with the first validation session to distinguish the first validation session from any other validation sessions;
transmit the nonce to the user device;
receive a reply from the user device, the reply comprising encrypted data from the contactless card and the nonce to indicate the encrypted data is associated with the first validation session;
transmit the encrypted data to a validation server to validate the encrypted data;
receive, from the validation server, an indication that the encrypted data has been validated, the indication including a validation token; and
transmit, to an issuer server, the validation token along with instructions to complete a function associated with the function request.

9. The switchboard node of claim 8, wherein as part of establishing the first validation session, the processing circuit is further caused to transmit a session token signed with a switchboard node private key and a terms of service acknowledgement request to the user device, wherein the nonce is contained within the session token.

10. The switchboard node of claim 9, wherein the processing circuit is further caused to receive, from the user device, a message indicating the terms of service are accepted by a user of the user account.

11. The switchboard node of claim 8, wherein the processing circuit is further caused to:
initiate a key negotiation between the issuer server and a merchant server associated with the function request,
wherein the issuer server and the merchant server are configured to exchange keys to decrypt messages communicated therebetween.

12. The switchboard node of claim 11, wherein the processing circuit is further caused to:
receive confirmation from the issuer server that the function has been completed; and
send the confirmation to the merchant server that the function has been completed.

13. The switchboard node of claim 8, wherein the user device is to send the nonce to the contactless card during a near field near-field communication (NFC) exchange between the user device and the contactless card; and
wherein the contactless card is to send the encrypted data to the user device during the NFC exchange.

14. The switchboard node of claim 8, wherein the function request includes at least one selected from the group of:
a request to perform an autofill function;
a request to execute or approve a transaction;
a request to login in to an account;
a request to actuate a controller; and
a request to establish a virtual private network (VPN).

15. A non-transitory computer-readable storage medium having instructions stored thereon, which when executed by a processor cause the process to:
receive a request for a first validation session, the first validation session being associated with a function request from a user device associated with a contactless card;
establish the first validation session and, as part of establishing the first validation session, generate a unique nonce associated with the first validation session to distinguish the first validation session from any other validation sessions;
transmit the nonce to the user device for the user device to send to the contactless card during a near field near-field communication (NFC) exchange between the user device and the contactless card;
receive a reply from the contactless card via the user device, the reply comprising encrypted data and the nonce to indicate the encrypted data is associated with the first session;
transmit the encrypted data to a validation server to validate the encrypted data;
receive, from the validation server, an indication that the encrypted data has been validated, the indication including a validation token; and
send, to an issuer server, the validation token along with instructions to complete a function associated with the function request.

16. The non-transitory computer-readable storage medium of claim 15, wherein as part of establishing the first validation session, the processor is further caused to transmit a session token signed with a switchboard node private key and a terms of service acknowledgement request to the user device, wherein the nonce is contained within the session token.

17. The non-transitory computer-readable storage medium of claim 16, wherein the processor is further caused to receive, from the user device, a message indicating the terms of service are accepted by a user of the user device.

18. The non-transitory computer-readable storage medium of claim 15, wherein the processor is further caused to:
initiate a key negotiation between the issuer server and a merchant server associated with the function request, wherein the issuer server and the merchant server are configured to exchange keys to decrypt messages communicated therebetween.

19. The non-transitory computer-readable storage medium of claim 15, wherein the processor is further caused to:
receive confirmation from the issuer server that the function has been completed; and
send the confirmation to the merchant server that the function has been completed.

20. The non-transitory computer-readable storage medium of claim 15, wherein the function request includes at least one selected from the group of:
a request to perform an autofill function;
a request to execute or approve a transaction;
a request to login in to an account;
a request to actuate a controller; and
a request to establish a virtual private network (VPN).
